(19) United States
(12) Patent Application Publication
(10) Pub. No.: US 2022/0003186 A1
(43) Pub. Date: Jan. 6, 2022

(54) PISTON FOR AN INTERNAL COMBUSTION ENGINE AND INTERNAL COMBUSTION ENGINE

(71) Applicant: Mahle International GmbH, Stuttgart (DE)

(72) Inventors: Alois Lecker, Stuttgart (DE); Reinhard Rose, Fellbach (DE)

(21) Appl. No.: 17/366,030

(22) Filed: Jul. 2, 2021

(30) Foreign Application Priority Data
Jul. 3, 2020 (DE) 102020208366.5

(51) Int. Cl. F02F 3/14

(52) U.S. Cl. CPC F02F 3/14

(57) ABSTRACT

A piston for an internal combustion engine may include a piston crown and a heat management coating. The heat management coating may be disposed on at least a region of an outer surface of the piston crown. The heat management coating may include a base layer and a functional layer. The base layer may be disposed between the piston crown and the functional layer, and may be adjoining the outer surface of the piston crown. The base layer may have a base layer matrix including a first polysilazane. The functional layer may have a functional layer matrix including a second polysilazane. The second polysilazane may be different from the first polysilazane.

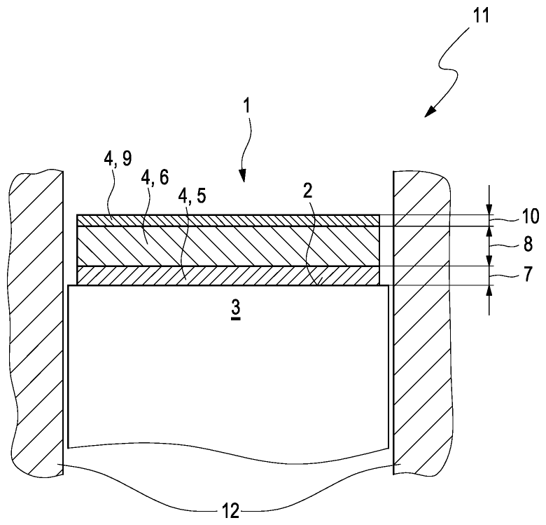

### CROSS-REFERENCE TO RELATED APPLICATIONS

This application claims priority to German Patent Application No. DE 10 2020 208 366.5, filed on Jul. 3, 2020, the contents of which is hereby incorporated by reference in its entirety.

### BACKGROUND

In order to improve thermal stability of pistons for an internal combustion engine, such pistons, as of recently, are provided with coatings on an outer surface of a piston crown of the piston. Furthermore, by means of such coatings, it is also possible to achieve protection of the coated outer surface of the piston from oxidation. In an internal combustion engine comprising the piston, such an outer surface of the piston crown typically partly bounds a combustion chamber of the internal combustion engine.

Against this background, EP 2 818 677 A1 discloses a piston for an internal combustion engine, on the outer surface of which is disposed, for improvement of the thermal stability of the piston, a three-layer heat management coating comprising an inorganic polysilazane.

However, it is found here to be disadvantageous that, by means of such a heat management coating, it is possible only in an inadequate manner to avoid impermissible heat absorption by the piston crown, which in the worst case can lead to failure of the piston.

### SUMMARY

It is therefore an object of the present invention—especially for eliminating the disadvantage indicated above—to show new approaches for pistons and for internal combustion engines including such a piston.

This object is achieved by the subject matter of the independent patent claim(s). Preferred embodiments are the subject of the dependent patent claim(s).

The basic idea of the invention is accordingly to specify a piston for an internal combustion engine, coated with a heat management coating comprising a base layer and a functional layer on an outer surface of a piston crown of the piston. The base layer here, in a first aspect of the invention, includes a first polysilazane, and the functional layer includes a second polysilazane other than the first polysilazane. In a second aspect of the invention, the base layer comprises nickel, or silicon dioxide filled with aluminum flakes, and the functional layer comprises an organic polysilazane.

Advantageously, such a heat management coating particularly effectively prevents successive absorption of heat by the piston crown or the piston, such that thermal stability of the piston is improved overall. It is additionally possible, by means of the heat management coating, in an advantageous manner, to improve protection of the coated outer surface of the piston crown from oxidation.

In a first aspect of the invention, which is usable for an internal combustion engine, especially for an internal combustion engine of a motor vehicle, a piston comprises a piston crown having an outer surface. This outer surface of the piston is preferably disposed on the end face at the piston crown. The piston crown appropriately comprises a piston material including an aluminum alloy or an iron alloy, or consists of a piston material including an aluminum alloy or an iron alloy. The piston also comprises a heat management coating disposed at least in some regions of the outer surface of the piston crown. The heat management coating comprises a base layer and a functional layer. The base layer of the heat management coating is disposed adjoining the outer surface of the piston crown and between the piston crown and the functional layer of the heat management coating. The base layer comprises a base layer matrix including a first polysilazane or consists of the first polysilazane. The functional layer comprises a functional layer matrix including a second polysilazane different from the first polysilazane. Alternatively, the functional layer consists of the second polysilazane. Such a heat management coating protects the piston crown particularly effectively from excessive heat input, and prevents or delays at least oxidation of the piston crown particularly efficiently.

In an advantageous development of the piston in the first aspect of the invention, the first polysilazane is an inorganic polysilazane and the second polysilazane is an organic polysilazane, or vice versa. By means of the organic polysilazane, it is advantageously possible to achieve particularly high layer thicknesses of the heat management coating, which achieves particularly good protection of the piston crown from excessive heat input. Moreover, the organic polysilazane can be admixed with additives in a particularly simple manner in order to optimize the properties of the heat management coating.

In a second aspect of the invention which is usable for an internal combustion engine, appropriately for a motor vehicle, a piston comprises a piston crown having an outer surface. This outer surface of the piston is preferably disposed on the end face at the piston crown. The piston crown preferably comprises a piston material including an aluminum alloy or an iron alloy, or consists of a piston material including an aluminum alloy or an iron alloy. The piston also includes a heat management coating disposed at least in some regions of the outer surface of the piston crown. The heat management coating comprises a base layer and a functional layer. The base layer is disposed between the piston crown and the functional layer, adjoining the outer surface of the piston crown. The base layer comprises nickel or silicon dioxide filled with aluminum flakes. Alternatively, the base layer consists of nickel or silicon dioxide filled with aluminum flakes. The functional layer comprises a functional layer matrix including an organic polysilazane or consists of the organic polysilazane. By means of such an organic polysilazane, it is advantageously possible, as already indicated above, to achieve particularly high layer thicknesses of the heat management coating, which can particularly effectively prevent unwanted heat absorption by the piston crown. Moreover, the organic polysilazane has particularly good additizability, such that the heat management coating is adjustable particularly efficiently with regard to optimal properties.

In an advantageous development of the piston according to both aspects of the invention, the base layer of the heat management coating has a base layer thickness, measured at right angles to the outer surface of the piston crown, of 0.2 μm to 2 μm. More preferably, the base layer thickness of the base layer is 0.2 μm to 0.6 μm. Such a base layer advantageously ensures particularly good adhesion of the heat management coating to the outer surface of the piston crown.

In both aspects of the invention, a further advantageous development of the piston envisages that the functional layer has a functional layer thickness, measured at right angles to the outer surface of the piston crown, of 50 μm to 100 μm. The functional layer thickness of the functional layer is preferably 50 μm to 70 μm. A functional layer in this form is found to be exceptionally heat-insulating.

In a further preferred development of the piston, in both aspects of the invention, the functional layer comprises hollow particles embedded in the functional layer matrix of the functional layer in the manner of a filler. This enhances the thermally insulating action of the functional layer.

The hollow particles appropriately take the form of hollow beads. Such hollow beads are producible particularly inexpensively.

In a further preferred development of the piston according to both aspects of the invention, the hollow particles comprise glass or consist of glass. Advantageously, such hollow glass particles are producible in a particularly simple manner and are also particularly inexpensive with regard to the raw materials to be used for production.

In a further preferred development of the piston according to both aspects of the invention, the functional layer comprises metal flakes embedded in the functional layer matrix in the manner of a filler. By means of such metal flakes, it is possible to even further improve the heat-shielding effect of the functional layer. Moreover, such a functional layer filled with metal flakes has particularly high mechanical strength.

In a further preferred development of the piston according to both aspects of the invention, the functional layer comprises mica embedded in the functional layer matrix in the manner of a filler. This means that the mica present in the functional layer may take the form of mica particles. More particularly, the mica particles may take the form of mica platelets, which means that the mica particles each have the geometry of a platelet. By means of the mica, it is possible to increase thermal stability of the functional layer.

In a further advantageous development of the piston according to both aspects of the invention, the heat management coating comprises an outer layer disposed on the functional layer, facing away from the piston crown. This outer layer is preferably thermally stable to at least 650° C. Such an outer layer advantageously protects the heat management coating from mechanical, thermal and/or chemical effects.

In a further preferred development of the piston according to both aspects of the invention, the outer layer comprises an inorganic polysilazane or consists of an inorganic polysilazane. Such an outer layer has particularly good adhesion to the functional layer.

In a further preferred development of the piston according to both aspects of the invention, the outer layer comprises a metal or consists of a metal. Such an outer layer is producible particularly inexpensively.

In a further preferred development of the piston according to both aspects of the invention, the outer layer has an outer layer thickness, measured at right angles to the outer surface of the piston crown, of 5 μm to 10 μm. Such an outer layer is found to be particularly effective.

In a further advantageous development of the piston according to both aspects of the invention, the outer layer is pore-free or has closed pores, such that the outer layer covers the functional layer of the heat management coating in an essentially gas-impermeable manner. This permits particularly good protection of the functional layer of the heat management coating by means of the outer layer.

The invention also relates to an internal combustion engine which is preferably usable for a motor vehicle. The internal combustion engine comprises at least one cylinder. The internal combustion engine also comprises a piston according to the first or second aspect of the invention, as described above. The piston of the internal combustion engine is guided within the cylinder of the internal combustion engine. The outer surface of the piston together with the cylinder partly bounds a combustion chamber of the internal combustion engine. The above-indicated advantages of the piston according to both aspects of the invention are also applicable to the internal combustion engine of the invention with such a piston.

Further important features and advantages of the invention will be apparent from the dependent claims, from the drawing and from the accompanying description of figures with reference to the drawing.

It will be apparent that the features mentioned above and those yet to be elucidated hereinafter are usable not just in the respective combination claimed but also in other combinations or on their own, without leaving the scope of the present invention.

Preferred working examples of the invention are shown in the drawing and are elucidated in detail in the description that follows.

### BRIEF DESCRIPTION OF THE DRAWING

The sole FIGURE shows a rough schematic of an example of an internal combustion engine of the invention.

### DETAILED DESCRIPTION

The sole FIGURE shows a rough schematic of an example of an internal combustion engine 11 of the invention, usable for a motor vehicle. The internal combustion engine 11 comprises a cylinder 12. Within the cylinder 12 of the internal combustion engine 11 is guided a piston 1 of the invention, likewise shown by way of example in the FIGURE. The piston 1, together with the cylinder 12, partly bounds a combustion chamber of the internal combustion engine 11 by an outer surface 2, for example at the end face, of the piston 1.

The FIGURE illustrates a piston 1 in a first aspect of the invention. According to this, the piston 1 has a piston crown 3 comprising the outer surface 2. The piston 1 also comprises a heat management coating 4 disposed at least in some regions of the outer surface 2 of the piston crown 3. The heat management coating 4 of the piston 1 comprises a base layer 5 and a functional layer 6. The base layer 5 is disposed between the piston crown 3 and the functional layer 6, adjoining the outer surface 2 of the piston crown 3. The base layer 5 comprises a base layer matrix including a first polysilazane or consisting of the first polysilazane. The functional layer 6 comprises a functional layer matrix including a second polysilazane—different from the first polysilazane—or consists of the second polysilazane. In the first aspect of the invention, the first polysilazane is an inorganic polysilazane and the second polysilazane is an organic polysilazane, or vice versa.

The FIGURE also illustrates, by way of example, a piston 1 for an internal combustion engine 11 in a second aspect of the invention, which is usable for a motor vehicle. According to this, the piston 1 comprises a piston crown 3 having the outer surface 2. The piston 1 further comprises a heat management coating 4 disposed at least in some regions of the outer surface 2 of the piston crown 3. The heat management coating 4 of the piston 1 comprises a base layer 5 and a functional layer 6. The base layer 5 is disposed between the piston crown 3 and the functional layer 6, adjoining the outer surface 2 of the piston crown 3. In the second aspect of the invention, the base layer 5 comprises nickel, or silicon dioxide filled with aluminum flakes, or consists of nickel, or silicon dioxide filled with aluminum flakes. The functional layer 6 comprises a functional layer matrix including organic polysilazane or consists of organic polysilazane.

As can also be appreciated with reference to the FIGURE, the base layer 5 of the piston 1, in both aspects of the invention, has a base layer thickness 7 measured at right angles to the outer surface 2 of the piston crown 3. The base layer thickness 7 of the base layer 5 is 0.2 μm to 2 μm, and in the example shown 0.2 μm to 0.6 μm. The functional layer 6 has a functional layer thickness 8 measured at right angles to the outer surface 2 of the piston crown 3. The functional layer thickness 8 of the functional layer 6 is 50 μm to 100 μm, and in the example shown 50 μm to 70 μm. The functional layer 8 comprises hollow particles embedded in the functional layer matrix of the functional layer 8 in the manner of a filler. The hollow particles take the form of hollow spheres. Such hollow spheres may, as a result of the manufacture, have a geometry slightly different from an ideal sphere. The hollow particles comprise glass or consist of glass. The functional layer 6 of the heat management coating 4 also comprises metal flakes embedded in the functional layer matrix of the functional layer 6 in the manner of a filler. Furthermore, the functional layer 6 comprises mica embedded in the functional layer matrix in the manner of a filler. The mica may be formed by mica platelets, meaning that the mica particles in this variant each have the geometry of a platelet.

It is also shown in the FIGURE that the heat management coating 4 comprises an outer layer 9 disposed on the functional layer 6, facing away from the piston crown 3. The outer layer 9 in the example shown is thermally stable up to at least 650° C. The outer layer 9 comprises an inorganic polysilazane or consists of an inorganic polysilazane. Alternatively, the outer layer comprises a metal or consists of a metal. The outer layer 9 has an outer layer thickness 10 measured at right angles to the outer surface 2 of the piston crown 3. The outer layer thickness 10 of the outer layer 9 is 5 μm to 10 μm. The outer layer 9 is pore-free or has closed pores. This means that the outer layer 9 has no pores or has solely closed pores. The outer layer 9 is in pore-free form or has closed pores in such a way that the outer layer 9 covers the functional layer 6 of the heat management coating 4 in an essentially gas-impermeable manner.

The piston crown 3 of the piston 1 comprises, for example, a piston material including an aluminum alloy or consists of a piston material including such an aluminum alloy. Alternatively, the piston crown 3 of the piston 1 comprises a piston material including an iron alloy or consists of a piston material including such an iron alloy.

1. A piston for an internal combustion engine, comprising:
a piston crown having an outer surface;
a heat management coating disposed on at least a region of the outer surface of the piston crown;
the heat management coating including a base layer and a functional layer;
the base layer disposed between the piston crown and the functional layer, and adjoining the outer surface of the piston crown;
the base layer having a base layer matrix including a first polysilazane;
the functional layer having a functional layer matrix including a second polysilazane; and
wherein the second polysilazane is different from the first polysilazane.

2. The piston according to claim 1, wherein one of the first polysilazane and the second polysilazane is an inorganic polysilazane and the other of the first polysilazane and the second polysilazane is an organic polysilazane.

3. A piston for an internal combustion engine, comprising:
a piston having an outer surface;
a heat management coating disposed on at least a region of the outer surface of the piston crown;
the heat management coating including a base layer and a functional layer;
the base layer disposed between the piston crown and the functional layer, and adjoining the outer surface of the piston crown;
the base layer including at least one of (i) nickel and (ii) silicon dioxide filled with a plurality of aluminum flakes; and
the functional layer having a functional layer matrix including an organic polysilazane.

4. The piston according to claim 1, wherein the base layer has a base layer thickness, measured at a right angler to the outer surface of the piston crown, of 0.2 micrometer to 2 micrometer.

5. The piston according to claim 1, wherein the functional layer has a functional layer thickness, measured at a right angle to the outer surface of the piston crown, of 50 micrometers to 100 micrometers

6. The piston according to claim 1, wherein the functional layer further includes a plurality of hollow particles embedded in the functional layer matrix in the manner of a filler.

7. The piston according to claim 6, wherein:
the plurality of hollow particles are structured as a plurality of hollow spheres; and
the plurality of hollow particles include glass.

8. The piston according to claim 1, wherein the functional layer further includes a plurality of metal flakes embedded in the functional layer matrix in the manner of a filler.

9. The piston according to claim 1, wherein the functional layer further includes mica embedded in the functional layer matrix in the manner of a filler.

10. The piston according to claim 1, wherein the heat management coating further includes an outer layer disposed on the functional layer facing away from the piston crown.

11. The piston according to claim 10, wherein the outer layer includes an inorganic polysilazane.

12. The piston according to claim 10, wherein the outer layer includes a metal.

13. The piston according to claim 10, wherein the outer layer has an outer layer thickness, measured at a right angle to the outer surface of the piston crown, of 5 micrometers to 10 micrometers.

14. The piston according to claim 10, wherein the outer layer at least one of (i) is pore-free and (ii) has closed pores, such that the outer layer covers the functional layer in an essentially gas-impermeable manner.

15. An internal combustion engine, comprising:
a cylinder;
the piston according to claim 1;
wherein the piston is guided movably within the cylinder in a stroke direction; and
wherein the outer surface of the piston, together with the cylinder, partly bounds a combustion chamber.

16. The piston according to claim 1, wherein the piston crown is composed of a piston material that includes at least one of an aluminum alloy and an iron alloy.

17. The piston according to claim 4, wherein the base layer thickness is 0.2 micrometer to 0.6 micrometer.

18. The piston according to claim 5, wherein the functional layer thickness is 50 micrometers to 70 micrometers.

19. The piston according to claim 10, wherein the outer layer is thermally stable up to at least 650° C.

20. An internal combustion engine, comprising:
a cylinder;
the piston according to claim 3;
wherein the piston is guided movably within the cylinder in a stroke direction; and
wherein the outer surface of the piston, together with the cylinder, partly bounds a combustion chamber.
